(19) United States
(12) Patent Application Publication
(10) Pub. No.: US 2004/0148215 A1
(43) Pub. Date: Jul. 29, 2004

(54) Computer network implemented payroll management system

(76) Inventors: John Visconti, Beverly Hills, CA (US); Rubin Rodriguez, Los Angeles, CA (US)

Correspondence Address: I. Michael Bak-Boychuk, Attorney at Law, P.O. Box 32501, Long Beach, CA, 90832, US

(21) Appl. No.: 10/350,929

(22) Filed: Jan. 24, 2003

(51) Int. Cl. G06F 17/60

(52) U.S. Cl. 705/9

(57) ABSTRACT

A computer network assisted accounting system is implemented with particular facility for manual intervention which thereafter is imbedded in the operational data. This arrangement is particularly suited for film and commercial production where the personnel engagement demands are extremely varied and irregular with the inventive payroll accounting system allowing for manual modification in each stage of the process. The system is then accessible over commercial networks to manage the payroll at various remote locations.

### BACKGROUND OF THE INVENTION

1. Field of the Invention

The present invention relates to a computer network implemented accounting method and system, and more particularly to a network distributed payroll accounting system conformed to integrate payroll data from various taxing jurisdictions, in various formats and forms, and in accordance with various employment terms, and based thereon to produce both a continuous accounting data stream together with periodic allocations and disbursements.

2. Description of the Prior Art

The efficient management of personnel is currently a matter of significant complexity and expense that requires specialized staffing skills, extensive training and management experience. In consequence the selection and retention of a proper managing staff is a matter of substantial attention, particularly where the employee expense represents a major component of the ongoing costs of the business. Simply, as the dominant cost of all business turns to the employee service cost more attention is required in the proper management of this cost. The recent strides in automation have not solved this trend. Instead, the current course of most business shows consistently a monotonic increase in the cost of labor and the efficient management of this cost is a paramount concern.

The management of labor costs is particularly difficult in enterprises which only sporadically require a large employee pool. In the first instance basic cost conservation demands that such businesses minimize the managing functions associated with this sporadic labor. Secondly, the broad variety of endeavors undertaken by these enterprises is often beyond the capacity of a consistently repeating labor pool. Thus the current business practice often resorts to temporary contract engagements as the primary staffing mechanism, and in the course of this effort various singular contracted obligations arise. These then are overlaid by the several statutory architectures incident to the engagement of labor, further compounded by the local, state and national wage taxing constraints.

One industry that is particularly characterized by these varied and temporary labor requirements is the entertainment industry. By its very nature, a motion picture or commercial producing enterprise commences with an original script which is then implemented with a performers' cast, that is then compounded by the particular geography of the site selection, and so on. This profoundly varying set of constraints has led to the evolution of staff leasing concerns which then attempt to coordinate between the demands of production enterprises and the individual demands of the labor, of course bounded by the various regulatory architectures. It is these buffering concerns that have been at the forefront of most personnel management automation techniques.

In the past various accounting systems and techniques have been devised which in one way or another assist in the collection of the employees' time records, exemplified by the teachings of U.S. Pat. Nos. 5,459,657 and 5,717,867 issued to Wynn, et al., for allocating and informing the management of the employees' time distributed amongst various concurrent projects, in coordination with the consumption of materials, as illustrated in U.S. Pat. No. 6,338,097 issued to Krenzke, et al., and for computing the employee's withholdings and net pay, as exemplified in U.S. Pat. No. 6,347,306 issued to Swart. While suitable for the purposes intended each of the foregoing teachings fails to attend to the systemic aspects of the technical problem, addressing specific aspects instead.

Those in the art will appreciate that a systemwise approach is required in order to render any employee managing process effective. For example, the production of a movie often entails periodic image sequences at a particularly remote geographic site which may lack the desired communication and infrastructure facilities. At the same time sound economics and local ordinances and other concerns may dictate that local labor be used together with at least some local supervision. Any management system will therefore need to be widely tolerant of the type and form of local input that may be effected by input devices at various evolutionary levels. Accordingly, the broadest levels of device tolerance are extensively desired, consistent with the limits of the network now generally known as the Internet, and it is one such system that is disclosed herein.

### SUMMARY OF THE INVENTION

Accordingly, it is the general purpose and object of the present invention to provide a computer network implemented payroll, timecard and accounting system arranged in substantially independent tiers all of which are complete in themselves.

Other objects of the invention are to provide a payroll accounting system organized to operate on existing communication networks such as the Internet.

Yet additional objects of the invention are to provide a computer network implemented accounting system conformed to adapt to various regulatory and tax collection constraints.

Yet further objects of the present invention are to provide a network implemented payroll, timecard and accounting system which is conveniently accessed by a wide range of communicating devices.

Briefly, these and other objects are accomplished within the present invention by way of a web-based interactive payroll, timecard and accounting system in which the various demands of a payroll system participants are integrated in a single web page. In this manner all the device tolerance aspects of a general utility communication network like the Internet are rendered useful in the course of the management and execution functions of payroll accounting, allowing for the management of a widely distributed employee staff, and particularly its payroll operations. The inventive system is therefore particularly useful for staff leasing enterprises, including those that service industries with periodic and widely varying staffing demands.

The use of this generally available, general purpose network is further rendered effective by severally layered security firewalls together with an interactive and distributed execution process that precludes active mischief by hackers from a single network access point. These firewalls are implemented by way of a bank of transaction servers like the Microsoft Transaction Server MTS that provide the component managing platform either by a process generally known as the Distributed interNet Architecture [DNA] on the Microsoft Windows NT system, or the Component Object Model [COM] on the Microsoft Windows 2000. These processes then control the operations behind the firewall thus formed, within and through a bank of commercially available servers, which may be used singly or in clustered groupings, such as one or more of the MS SQL 7.0 Server again provided by Microsoft, Inc. The progression patterns through these tiers of ‘back end’ servers is effected by a unique set of database paths further permutated by the level of data access and control authority associated with each user identification or password. This much smaller subset of the necessary matrix combinations within the larger universe of all possible path permutations, together with the authority hierarchy assigned to users to manage and amend data subsets assigned to user identifications and the unique data architecture provide a virtually impenetrable shield to the outside world, i.e., a firewall. This shield that renders useful the inventive payroll accounting system described herein.

Those in the art will appreciate that some of the most sensitive business data is the data related to the wages, net take home pay and pay rates of employees. Imbedded in this data set are very personal items like tax withholding levels, possible garnishment or lien issues, the rate paid to the particular employee and any other particulars of this employee's engagement. In the entertainment business this is further compounded by highly personalized and hotly negotiated engagement terms, known as the ‘deal memos’ that specify not just the rate but also the other terms like accommodations, lunch or rest periods and the like. Further complicating matters is the frequent mixing of the labor force precipitated by remote geographic instances of ‘on location’ scenes and the associated necessity for system access by a broad range of communication devices. Consequently, the system that relies on the use of generally accessible public communication networks also needs to rely on widely vended and therefore used mechanisms including broadly useful operating languages therefor, such as the XML, HTML and IIS (Internet Information Server), and the instant inventive system therefore implements the complex gross and net pay computations, the several management reports, and even automated banking within a system based on generally available devices based on an architecture that itself assures complete security. With this assurance of security the necessary, network distributed tasks of net pay, gross pay, accounts payable and so on can be carried out in one or more computation engines, taking into account local cost factors and the various layers of statutory requirements and local regulations. The employee force is thus assured proper payments at all locations.

### BRIEF DESCRIPTION OF THE DRAWINGS

FIG. 1 is a diagrammatic illustration of the inventive automated payroll accounting system architecture useful in the execution and security of the payroll transactions effected within the present invention;

FIG. 2 is a generalized flow chart illustrating the data inputs and the logical operations thereon in accordance with the present invention;

FIG. 3 is a schematic illustration of the primary screen layout of a web page useful in effecting the several operations described herein; and

FIGS. 4a and 4b are further illustrations of subordinate pages invoked with the assistance of the selection options available in FIG. 3.

### DESCRIPTION OF THE PREFERRED EMBODIMENT

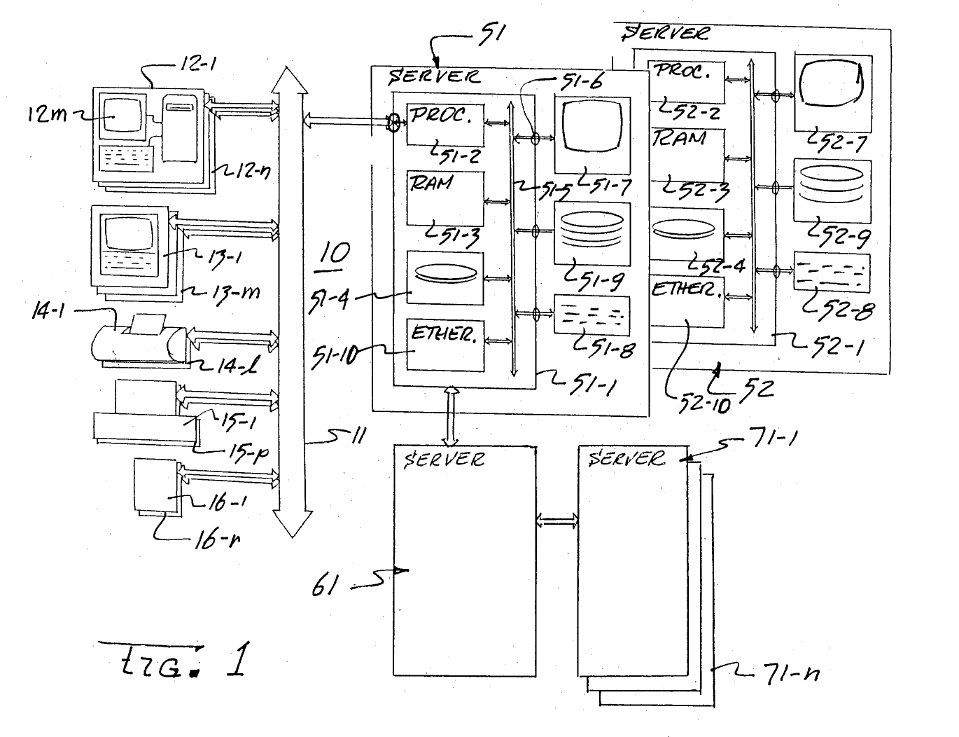

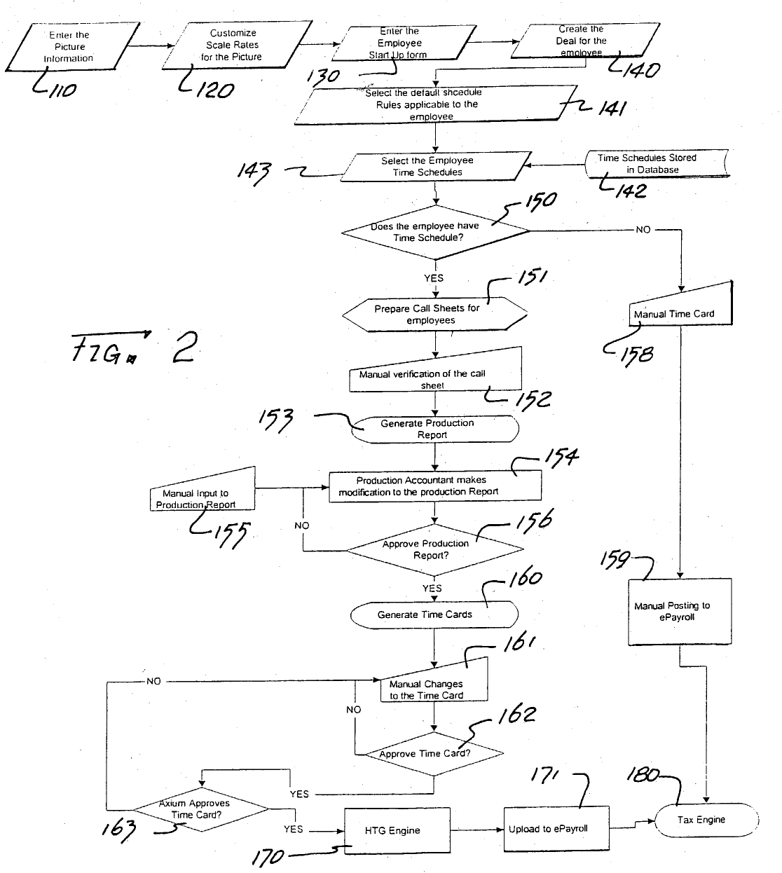

As shown in FIGS. 1-3 the inventive payroll accounting and management system, generally designated by the numeral 10, is implemented as a computer communication system of general utility and configuration and including a network 11 to which all sorts of commercially available devices can be tied, exemplified by a group of IBM compatible personal computers 12-1 through 12-n, a set of Apple based personal computers 13-1 through 13-m, one or more remotely accessible printing facilities 14-1 through 14-1, various workstations 15-1 through 15-p and appropriately accommodated handheld devices or PDAs 16-1 through 16-r. Of course, the foregoing exemplary list exists in a constantly developing setting and other types may come to the marketplace each adapted to the generalized architecture of the network and no intent to limit the range of included devices is expressed by the foregoing list. Characteristically, each of these devices includes its own communication interface which is continuously on or which may operate in short bursts as is now practiced in the various PDAs, including their own, separate, but now well known network browsers. Access by the full breadth of the communicating devices is particularly useful in network communications across wide geographic areas, a feature of particular significance to those engaged in managing movie production at various remote sites.

Also connected to the network 11 are a first and a second servers 51 and 52 each generally configured as a Microsoft Windows IIS Web server or a Microsoft Transaction Server MTS and each including a component management platform for executing such component operations as are properly invoked. In conventional practice servers 51 and 52 are each implemented as a data processing system including a processing unit 51-1 and 52-1 characterized by a processor 51-2 and 52-2, a temporary storage 51-3 and 52-3, a permanent storage like a hard disc 51-4 and 52-4, and an internal bus 51-5 and 52-5 connecting all these to a plurality of input/output interfaces 51-6 and 52-6. The I/O interfaces 51-6 and 52-6 may then communicate with a corresponding video monitor 51-7 and 52-7, a keyboard 51-8 and 52-8 and a mass memory like a disc rack 51-9 and 52-9 all controlled by the server system resident thereon. In addition, an Ethernet controller 51-10 and 52-10 may be included in each of the servers 51 and 52, assisting in the manner generally described in U.S. Pat. No. 4,063,220 issued to Metcalfe et al. with the communications between these and the several other components described below. At the other end each of the servers 51 and 52 is managed and controlled in its communications with the network 11 by way of network interfaces 51-l and 52-11 generally known as server network interface cards. As will be more precisely described below, by this arrangement the two servers 51 and 52 effectively provide a traffic control interface between the network 11 and any other systems and devices, this interface thus being useful to assure the necessary level of security to any databases supporting the servers.

The security obtained in the first line of servers is further enhanced by an n-tier architecture of the subordinate server array, illustrated herein as a first layer server 61 operating as a distributor and publisher of the data obtained and assembled from the lower tier servers 71-1 through 71-n. Preferably, each of these tiered servers are of the relational database type such as the Microsoft SQL server which is particularly suited for remote data access. Thus any data distributed across servers 61 and 71-1 through 71-n will require pointer or address notations that are finely granulated and this granulation, by itself, is used to provide security.

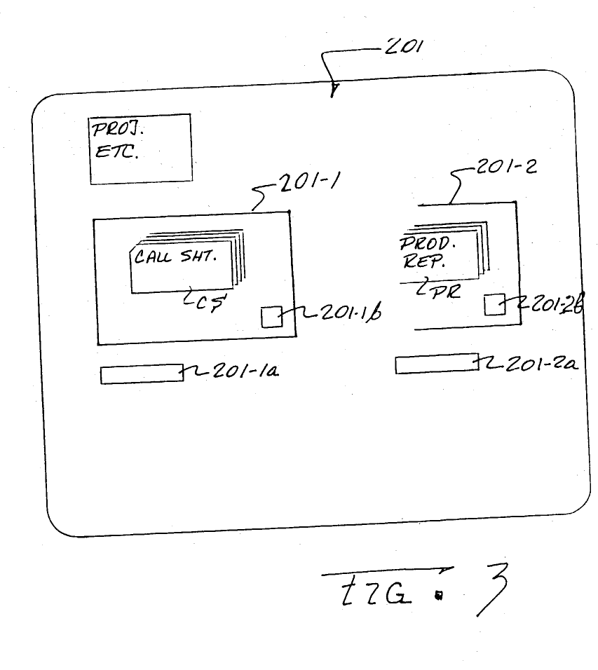

The communicating device, like the IBM compatible personal computer 12, selects the server bank including servers 51 and 52 which, based on the correct interpretation of the user's identification and password, may return a particular screen image 201 on the monitor 12m which, by itself, limits the address options available. As shown particularly in FIG. 3 this screen image 201 provides the entry point to the inventive payroll managing system generally shown at 100. The screen image 201 is therefore an entry gate to an accounting system generally organized and effected by way of the primary setup step 110 in which the project is identified, the revenue source(s) (accounts) or bank(s) are identified, as is the production company or unit. Then in step 120 the customized scale rates or limits of the individual production contract, such as funding control, local/remote funding disbursement and similar boundaries are installed. These then set the various coefficients, multiplication factors, and other variables of the accounting computations in step 130 associated with the particular employee which are then further modified in step 140 by the individual employee's employment terms (deal memo), the various call schedules sometimes defining a sporadic employment, and other individual employment arrangements together with the data from various automated default schedule rules 141 which then set the particular employee's time schedules stored in step 142 then verified against any union or other contract terms in a template comparison in step 143 to determine if there is a time schedule in a branching step 150.

Upon determining that a time schedule is available for the employee the inventive system then generates in step 151 the call sheets that are again manually verified in step 152 in the course of generating a management (production) report in step 153. This production report is also looped through a manual adjustment cycle comprising an accounting modification step 154 that is invoked by a manual input 155 if a branching test 156 denies approval. Upon completed adjustment or approval the sequence is advanced to an automated time card generating step 160 which is similarly passed through a manual intervention step 161 and a branching step 162 in which the time card under inspection is manually checked. This same inspection may be also carried out at a higher, management level in step 163 which the also loops through the manual step 161. Once these manual verifications are done the time card is processed in step 170 as a cost entry and then posted into the payroll account in step 171. Thereafter the individual payroll data is processed for all tax withholdings, levies, assessments and/or possible garnishments in step 180 to produce a net payment to the employee.

In the foregoing sequence branching steps 150, 156, 162 and 163, together with the call sheet verification step 152, each loop back to manual intervention, with step 150 transferring the whole time card generation process to a manual step 158 that then ends in a manual payroll posting step 159 feeding the final pay step 180 if the particular employee has no time schedule. Steps 152, 156, 162 and 163, however, are steps that are iterative and therefore eventually self-eradicating and once the appropriate adjustments and corrections are manually inserted use of default settings can then take over, streamlining the process to a fully automated form. As a consequence, the flexibility of the foregoing inventive system allows for a controlled approach to payroll accounting problems that are often initially very cumbersome and as the manual intervention process is adjusted by iteration those items that require most manual attention are quickly exposed with the balance deferred to default settings. Step 180 then automatically collects the various withholding parameters like those on the 19 or W4 Internal Revenue Service tax forms, together with such other local data like any local income withholdings or surcharge. Also included in this step is an examination for any garnishments or liens or other automated withholding like that for any one of the retirement plans that may be in effect. The resulting distributions are then variously posted to produce the employee's paycheck and the several withholding credits. In this manner the inclusion of manual screen image enabled adjustment steps in the process allows for a learning curve during which the particular unique aspects of the project are adjusted by screen image forms, each accessible by the particular specialist within a preset hierarchy of command.

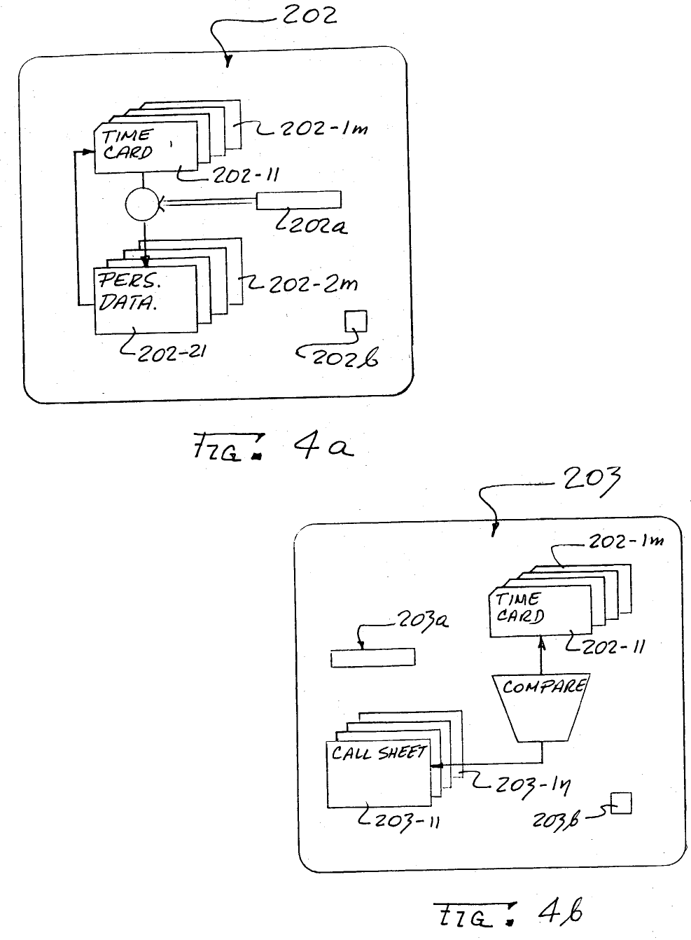

Referring now to FIGS. 3, 4a, 4b and 4c the hierarchy of screen images that are necessary to effect the foregoing manual iterations commencing with a primary image 201 informing the management, like the summary presentations of the production budget and schedule, chart of accounts, payables to receivables balances, purchase orders against delivery and so on, together with any scheduling call sheets and other production sequence details. Screen image 201, therefore, conforms to the manual data input requirements of both the steps 152 and 155, shown as options 201-1 and 201-2 that are each separately accessible by appropriate pass code entries in field 201-1a and 201-2a. Screen portion 201-1, for example, may allow access to the call sheets CS, as in step 152, while concurrently displaying the production report PR in portion 201-2. Once again, manual access to the production report data, per step 155, can be effected by yet another pass code entry 201-2a entered by the appropriately authorized member of the accounting staff. Once appropriate corrections are thus entered in both the call sheets CS and the production report PR such can then serve as the default settings thereafter. A set of default selectors 201-1b and 201-2b is rendered useful to effect this selection. In this manner the experience in accumulated in the particular endeavor is preserved, further advancing the convenience and effectiveness of the inventive accounting system disclosed herein.

In similar implementation the manual time card input in step 161 is effected with the assistance of image screen 202 which displays the time card information TC of a selected employee. Once again an appropriate pass code is required in field 202a which then provides access to the various employees' time card information as several data display options 202-11 through 202-1m to the person authorized to correct time cards, limited however in the range of data input. Simply, this management function looped through branching step 162 is limited to time card oversight only. Branching step 163, on the other hand, may include further time card adjustments with authority to modify account postings to reconcile the project with the contract terms. This expanded authority is again determined by the pass code entered into field 202a which allows further data access into the employees' time card display options shown as data displays 202-21 through 202-2m. Of course, the same level of access is required in those instances where the branching step 150 indicates that there is no time schedule for the particular employee. Manual intervention is then fully available by way of the same two access processes described above. Those skilled in the art will note that this manual data override facility allows for iterative adjustment of very complex processes which can then be imbedded into the system as default settings by the default selectors 202b. In this manner full flexibility is obtained in a system in which at least two levels of data security are provided, with the more sensitive data deferred to higher levels of management.

Employee scheduling, or call sheets, are similarly implemented for manual adjustment with the assistance of screen image 203 which again requires appropriate pass code entry in field 203a thereafter fixed by default settings 203b. These call sheets 203-11 through 203-1n are then manually confirmed against the corresponding time cards, with the gross payroll functions, time card input, employee hours-to-gross conversions, scheduling and similar middle level issues, thus fully accommodated in the inventive system. These parameters are then expanded by inputs such as the withholding and tax rate, local and regional tax charges, garnishments, direct bank deposit and so on, in step 180 to produce the employees' wage payments.

Those in the art will appreciate that the foregoing system architecture servers accommodates pass code protected access granulation at the most personal data levels. This organization of data may also take benefit of a tiered physical device architecture which by a tiered architecture of servers 61 and 71-1 through 71-n. The system therefore provides the necessary management flexibility while also attending to security concerns.

Obviously, many modifications and variations can be effected in light of the foregoing teachings without departing from the spirit of the invention disclosed herein. It is therefore intended that the scope of the instant invention be determined solely by the claims appended hereto.

It is claimed:

1. A method for managing the employee scheduling and payroll of a film production endeavor, comprising the steps of:
entering into a network connected computer system the terms of engagement of each employee initially engaged for said film production endeavor;
setting a preliminary schedule for each said initially engaged employee by way of default settings in said computer system;
determining if a particular employee is provided a preliminary schedule and providing a call sheet to each said employee that has been determined to have been provided a preliminary schedule and manually producing a first time card for each employee not provided with a preliminary schedule;
generating a production report on the bases of a cumulation within said computer system of said preliminary schedules;
manually adjusting said production report;
issuing a second time card within said computer system for each said employee determined to have been provided a preliminary schedule; and
combining said first and second time cards and said terms of engagement to produce wage payment and withholding data within said computer system for each said employee.

2. A method, according to claim 1, comprising the further step of:
manually changing selected ones of said second time cards as are not approved in the course of said cumulation during said step of generating said production report.

3. A method according to claim 2, wherein:
the step of manually producing said first time cards and the step of manually changing said selected ones of said second time cards each further include the step of posting debits and credits into corresponding entry ledgers within said computer system in accordance with said terms of engagement.

4. A method according to claim 1, wherein:
the step of manually producing said first time cards and the step of issuing said second time cards each further include the step of posting debits and credits into corresponding entry ledgers within said computer system in accordance with said terms of engagement.

5. A method, according to claim 4, comprising the further step of:
manually changing selected ones of said second time cards as are not approved in the course of said cumulation during said step of generating said production report.

6. A method for managing the employee scheduling and payroll of a film production endeavor, comprising the steps of:
entering into a network connected computer system the terms of engagement of each employee initially engaged for said film production endeavor;
setting a preliminary schedule for each said initially engaged employee by way of default settings in said computer system;
determining if a particular employee is provided a preliminary schedule and providing a call sheet to each said employee that has been determined to have been provided a preliminary schedule and manually producing a first time card for each employee not provided with a preliminary schedule;
generating a production report on the bases of a cumulation within said computer system of said preliminary schedules;
issuing a second time card within said computer system for each said employee determined to have been provided a preliminary schedule;
manually changing selected ones of said second time cards as are not approved in the course of said cumulation during said step of generating said production report and concurrently amending the corresponding ones of said default settings;
posting debits and credits into corresponding entry ledgers within said computer system in accordance with said terms of engagement for each said first and second time cards; and
combining said postings corresponding to said first and second time cards to produce wage payment and withholding data within said computer system for each said employee.

7. A method according to claim 6, further comprising the step of:
manually adjusting said production report.

8. A method according to claim 7, wherein:
said wage payments are transmitted by way of said network.

9. A method for managing the employee scheduling and payroll in the course of a film production endeavor, comprising the steps of:
entering into a network connected computer system the terms of engagement for each employee initially engaged for said film production endeavor;
setting a preliminary schedule for each said initially engaged employee by way of default settings in said computer system;
determining if a particular employee is provided a preliminary schedule and providing a call sheet to each said employee that has been determined to have been provided a preliminary schedule and manually producing a first time card for each employee not provided with a preliminary schedule;
generating a production report on the bases of a cumulation within said computer system of said preliminary schedules;
manually adjusting said production report;
issuing a second time card within said computer system for each said employee determined to have been provided a preliminary schedule;
manually changing selected ones of said second time cards as are not approved in the course of said cumulation during said step of generating said production report;
resetting said default settings in accordance with the step of manually changing; and
combining said first and second time cards and said terms of engagement to produce wage payment and withholding data within said computer system for each said employee.

10. A method according to claim 9, wherein said step of combining further includes:
posting debits and credits into corresponding entry ledgers within said computer system in accordance with said terms of engagement for each said first and second time cards; and
crediting said postings corresponding to said first and second time cards to produce wage payment and withholding data within said computer system for each said employee.
